(19) United States
(12) Patent Application Publication
(10) Pub. No.: US 2012/0148340 A1
(43) Pub. Date: Jun. 14, 2012

(54) BICYCLE FOLDER WITH SELF-LOCKING DEVICE

(75) Inventors: Weilong Tan, Guangdong (CN); Mingxi Tang, Guangdong (CN); Yichuan Chen, Guangdong (CN)

(73) Assignee: Shenzhen Xidesheng Bicycle Co., Ltd., Shenzhen, Guangdong Province (CN)

(21) Appl. No.: 13/391,627

(22) PCT Filed: Nov. 8, 2010
(86) PCT No.: PCT/CN2010/078496

§ 371 Date: Feb. 22, 2012

(30) Foreign Application Priority Data
Jul. 1, 2010 (CN) 201020250103

(51) Int. Cl. F16B 21/00

(52) U.S. Cl. 403/325; 403/321

(57) ABSTRACT

The present invention relates to a bicycle folder with a self-locking device, which can lock the handle of the folder, consists of front and rear folding leaves of the folder and a quick release handle. The quick release handle is mounted on the front folding leaf of the folder, and tightly locked on the front and rear folding leaves of the folded folder after they are folded. A locking buckle is provided on said quick release handle, and a locking tongue is provided on a bicycle tube. The locking tongue is locked in the locking buckle of the quick release handle which can tightly lock the folder. Said locking tongue is composed of a position limit handle and a handle shaft, and has a certain clearance from the bicycle tube. The present invention can reduce structure precision requirements of a four-link adjustment mechanism or other adjustment means in the quick release handle, avoid the unexpected trigger of the handle, and prevent the accidents of the releasing of the handle and the loosening of the folder. By the cooperation between the inclined surface and the weight block of the position limit handle, a self-locking function is easy to realize. A locking force is then increased under the torsion action of a torsion spring, thus enabling the self-locking structure to be safer.

### BACKGROUND OF THE INVENTION

The present invention relates to a folded bicycle accessory and, more particularly, to a bicycle folder with a self-locking device which can lock the handle of the folder.

In the market, a conventional bicycle folder generally is a handle locking mechanism which has a complex structure and so-called quick operation. This type of folder merely makes the front and rear folding leaves of the folder lock together by a four-link adjustment mechanism or other adjustment means. Such structure is relatively complex and easy to produce misalignment after deforming and so on.

### BRIEF SUMMARY OF THE INVENTION

To solve above-mentioned drawbacks, the present invention provides a bicycle folder with a self-locking device, which can lock the handle of the folder.

The present invention can be achieved by the following technical means:

The bicycle folder with a self-locking of the present invention, is composed of front and rear folding leaves of the folder and a quick release handle, the quick release handle is mounted on the front folding leaf of the folder, and tightly locked on the front and rear folding leaves of the folded folder after they are folded; a locking buckle is provided on said quick release handle, and a locking tongue is provided on a bicycle tube; the locking tongue is locked in the locking buckle of the quick release handle which can tightly lock the folder; said locking tongue is composed of a position limit handle and a handle shaft, and has a certain clearance from the bicycle tube; the position limit handle is curved ruler-shaped and can revolve 0-60° in horizontal direction around the handle shaft which is mounted on the position limit handle; one end of said position limit handle which contacts with the locking buckle is an inclined surface, when locking tightly, the locking buckle can press down the position limit handle by the inclined surface and then enter into the clearance between the position limit handle and bicycle tube; the other end of the position limit handle is a weight block which can make the end of the position limit handle contacting with the locking buckle always maintain an upwards state by the gravity action.

The locking tongue further includes a torsion spring which is mounted in the position limit handle, the position limit handle and torsion spring are fixed onto the bicycle tube by the handle shaft, and the torsion spring also can make the end of the position limit handle which contacts with the locking buckle always maintain an upwards state by spring force.

The locking buckle is composed of a pin which has a taper end and a piece of metal tongue which is fixed onto the quick release handle by the pin, the clearance height between the tongue and the quick release handle is a little bigger than the thickness of the position limit handle.

The handle shaft is mounted on the end which is close to the locking buckle, and the arm of force of the end where the weight block is provided is relatively long. Thus, based on lever principle, if want to open the folder, merely need to rise the end of the position limit handle where the weight block is provided, thereby opening the folder easily.

The position of the locking buckle and that of the locking tongue can be exchanged according to actual need.

The bicycle folder with a self-locking device of the present invention can reduce structure precision requirements of a four-link adjustment mechanism or other adjustment means in the quick release handle, avoid the unexpected trigger of the handle, and prevent the accidents of the releasing of the handle and the loosening of the folder. By the cooperation between the inclined surface and the weight block of the position limit handle, a self-locking function is easy to realize. A locking force is then increased under the torsion action of a torsion spring, thus enabling the self-locking structure to be safer.

### BRIEF DESCRIPTION OF THE DRAWINGS

FIG. 1 is a state diagram showing that the quick release handle of the present invention is in an open state;

FIG. 2 is a state diagram showing that the quick release handle of the present invention is going to be locked;

FIG. 3 is a state diagram showing that the quick release handle of the present invention has been locked.

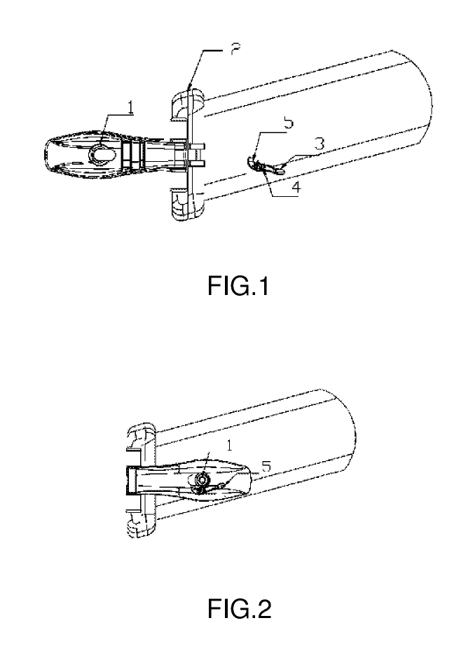

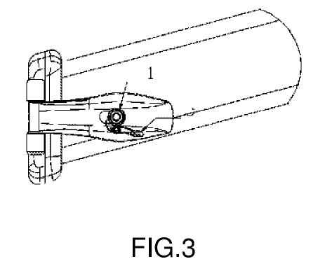

### DETAILED DESCRIPTION OF THE INVENTION

According to the figures, the bicycle folder 2 with a self-locking of the present invention consists of a front and rear folding leaves of the folder 2 and a quick release handle thereof. The quick release handle is mounted on a front folding leave of the folder 2 and locked at the front and rear folding leaves of the folded folder. The quick release handle has a locking buckle 1 mounted thereon, a locking tongue 5 is provided on a bicycle tube and locked at the locking buckle 1 of the quick release handle of the folder 2. The locking tongue 5 is composed of a position limit handle 3, a handle shaft and a torsion spring 4. The position limit handle 3 is curved ruler-shaped and can revolve 0-60° in horizontal direction around the handle shaft which is mounted on the position limit handle 3. The torsion spring 4 is mounted in the position limit handle 3, and the position limit handle 3 and torsion spring 4 are fixed onto the bicycle tube by the handle shaft. The locking buckle 1 is composed of a pin which has a taper end and a piece of metal tongue which is fixed onto the quick release handle by the pin. The clearance height between the tongue and the quick release handle is a little bigger than the thickness of the position limit handle 3.

When the bicycle folder 2 with a self-locking of the present invention in an opening state, it is not different from the conventional bicycle folder; during the quick release handle locking the front and rear folding leaves of the folder, the taper end of the locking buckle 1 of the quick release handle props up the position limit handle 3 until the curved ruler end slides into the clearance between the tongue of the locking buckle 1 and the quick release handle; when the quick release handle has locked the front and rear folding leaves of the folder, the position limit handle 3 locks the quick release handle simply and easily by the action of torsion spring 4.

When the bicycle folder 2 with a self-locking of the present invention in an locking state, merely need to operate the position limit handle 3 which is fixed on the bicycle tube and make the locking tongue 5 withdraw from the locking buckle 2, thereby pulling the quick release handle and then open the folder.

The end of the position limit handle 3 which contacts with the locking buckle 1 is an inclined surface, which makes the locking buckle 1 slide into the clearance between the position limit handle 3 and bicycle tube more easily. The handle shaft is provided on the end which is close to the locking buckle 1, the arm of force of the other end of the position limit handle is relatively long and the end is a weight block to ensure that the contact end of the position limit handle 3 maintains an upwards state, thereby increasing the stability of the locking action of the folder.

The bicycle folder with a self-locking of the present invention can lock the quick release handle which is used to lock the front and rear folding leaves of the folder merely by the action of interference fit, thereby locking reliably and adjusting expediently.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A bicycle folder with a self-locking device, consists of front and rear folding leaves of the folder and a quick release handle, the quick release handle is mounted on the front folding leaf of the folder, and tightly locked on the front and rear folding leaves of the folded folder after they are folded, wherein a locking buckle is provided on said quick release handle, and a locking tongue is provided on a bicycle tube; the locking tongue is locked in the locking buckle of the quick release handle which can tightly lock the folder; said locking tongue is composed of a position limit handle and a handle shaft, and has a certain clearance from the bicycle tube; the position limit handle is curved ruler-shaped and can revolve 0-60° in horizontal direction around the handle shaft which is mounted on the position limit handle; one end of said position limit handle which contacts with the locking buckle is an inclined surface, when locking tightly, the locking buckle can press down the position limit handle by the inclined surface and then enter into the clearance between the position limit handle and bicycle tube; the other end of the position limit handle is a weight block which can make the end of the position limit handle contacting with the locking buckle always maintain an upwards state by the gravity action.

2. The bicycle folder with a self-locking device according to claim 1, wherein the locking tongue further comprises a torsion spring which is mounted in the position limit handle, the position limit handle and torsion spring are fixed onto the bicycle tube by the handle shaft, and the torsion spring also can make the end of the position limit handle which contacts with the locking buckle always maintain an upwards state by spring force.

3. The bicycle folder with a self-locking device according to claim 1, wherein the locking buckle is composed of a pin which has a taper end and a piece of metal tongue which is fixed onto the quick release handle by the pin, the clearance height between the tongue and the quick release handle is a little bigger than the thickness of the position limit handle.

4. The bicycle folder with a self-locking device according to claim 2, wherein the handle shaft is mounted on the end which is close to the locking buckle and the arm of force of the end where the weight block is provided is relatively long.

5. The bicycle folder with a self-locking device according to claim 1, wherein the position of the locking buckle and that of the locking tongue can be exchanged, and the locking buckle is mounted on the bicycle tube and the locking tongue is mounted on the quick release handle.
